(19) United States
(12) Patent Application Publication
(10) Pub. No.: US 2026/0251810 A1
(43) Pub. Date: Aug. 27, 2026

(54) SEISMIC HORIZON TRACKING FRAMEWORK

(71) Applicant: Schlumberger Technology Corporation, Sugar Land, TX (US)

(72) Inventor: Zhun LI, Houston, TX (US)

(21) Appl. No.: 18/993,943

(22) PCT Filed: Jul. 13, 2023
(86) PCT No.: PCT/US2023/070110

§ 371 Date: Jan. 13, 2025

Related U.S. Application Data
(60) Provisional application No. 63/388,759, filed on Jul. 13, 2022.

(51) Int. Cl. G01V 1/30

(52) U.S. Cl. CPC G01V 1/301; G01V 2210/643

(57) ABSTRACT

A method can include receiving seismic data from a seismic survey of a subsurface region and tracking a horizon of the subsurface region in the seismic data via an optimization process that minimizes a grid-based loss function using a machine learning model where the method can include outputting the tracked horizon, for example, for model building, simulation and/or identification of hydrocarbons or other objects in the subsurface region.

### RELATED APPLICATION

This application claims priority to and the benefit of a US Provisional Application having Ser. No. 63/388,759, filed 13 Jul. 2022, which is incorporated by reference herein in its entirety.

### BACKGROUND

A reservoir can be a subsurface formation that can be characterized at least in part by its porosity and fluid permeability. As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

Reflection seismology finds use in geophysics, for example, to estimate properties of subsurface formations (e.g., to characterize a subterranean environment with one or more formations). Reflection seismology can provide seismic data representing waves of elastic energy (e.g., as transmitted by P-waves and S-waves, in a frequency range of approximately 1 Hz to approximately 100 Hz). Seismic data can be processed and interpreted, for example, to understand better composition, fluid content, extent and geometry of subsurface rocks. Reflection seismology data from a seismic survey can be used to understand or characterize one or more subsurface formations.

In oil and gas exploration, interpretation is a process that involves analysis of data to identify and locate various subsurface structures (e.g., horizons, faults, geobodies, etc.) in a geologic environment. Such data can include reflection seismology data. Various types of structures (e.g., stratigraphic formations) may be indicative of hydrocarbon traps or flow channels, as may be associated with one or more reservoirs (e.g., fluid reservoirs). In the field of resource extraction, enhancements to interpretation can allow for construction of a more accurate model of a subsurface region, which, in turn, may improve characterization of the subsurface region for purposes of identification of locations of hydrocarbons and resource extraction. Characterization of one or more subsurface regions in a geologic environment can guide, for example, performance of one or more operations (e.g., field operations, etc.). As an example, a more accurate model of a subsurface region may make a drilling operation more accurate as to a borehole's trajectory where the borehole is to have a trajectory that penetrates a reservoir, etc., where fluid may be produced via the borehole (e.g., as a completed well, etc.). One or more workflows may be performed using one or more computational frameworks and/or one or more pieces of equipment that include features for one or more of analysis, acquisition, model building, control, etc., for exploration, interpretation, drilling, fracturing, production, etc.

### SUMMARY

A method can include receiving seismic data from a seismic survey of a subsurface region; tracking a horizon of the subsurface region in the seismic data via an optimization process that minimizes a grid-based loss function using a machine learning model; and outputting the tracked horizon.

A system can include a processor; a memory accessible by the processor; processor-executable instructions stored in the memory and executable to instruct the system to: receive seismic data from a seismic survey of a subsurface region; track a horizon of the subsurface region in the seismic data via an optimization process that minimizes a grid-based loss function using a machine learning model; and output the tracked horizon.

One or more non-transitory computer-readable storage media can include computer-executable instructions executable to instruct a computing system to: receive seismic data from a seismic survey of a subsurface region; track a horizon of the subsurface region in the seismic data via an optimization process that minimizes a grid-based loss function using a machine learning model; and output the tracked horizon.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a geologic environment and an example of a system;

FIG. 2 illustrates examples of techniques;

FIG. 3 illustrates an example of a subsurface region, an example of a method, examples of tools, an example of a convention and an example of a system;

FIG. 4 illustrates examples of seismic survey equipment;

FIG. 5 illustrates examples of seismic surveys;

FIG. 6 illustrates an example of framework;

FIG. 7 illustrates an example of a tracking method;

FIG. 8 illustrates examples of tracked horizons and artefacts;

FIG. 9 illustrates examples of traces and flow fields;

FIG. 10 illustrates an example of a grid;

FIG. 11 illustrates examples of improved tracked horizons;

FIG. 12 illustrates an example of a framework;

FIG. 13 illustrates an example of a method and an example of a system; and

FIG. 14 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

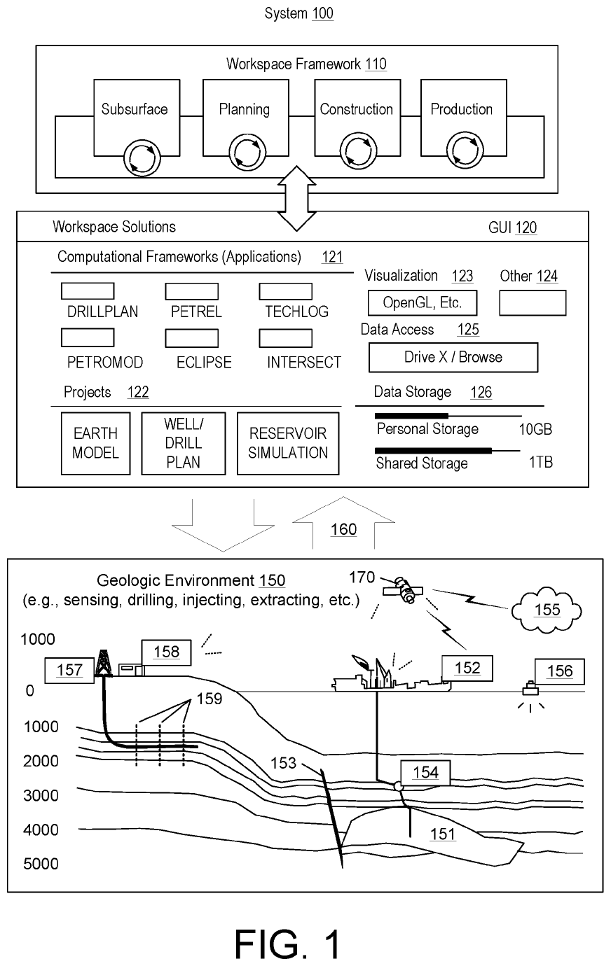

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, and INTERSECT frameworks (SLB, Houston, Texas); noting that one or more other frameworks may be included, additionally, alternatively, etc.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive exploration and production (E&P) environment (SLB, Houston, Texas), referred to as the DELFI environment, for utilization in geosciences and geoengineering, for example, to analyze subsurface data from exploration to production of fluid from a reservoir.

The DELFI environment is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, machine learning models, etc.).

As an example, the DRILLOPS framework (SLB, Houston, Texas) can be included with and/or operatively coupled to the DELFI framework. The DRILLOPS framework can execute a digital drilling plan and help to ensure plan adherence, while delivering goal-based automation. The DRILLOPS framework can generate activity plans automatically individual operations, whether they are monitored and/or controlled on the rig or in town. Automation can utilize data analysis and learning systems to assist and optimize tasks, such as, for example, setting ROP to drilling a stand. A preset menu of automatable drilling tasks can be rendered, and, using data analysis and models, a plan can be executed in a manner to achieve a specified goal, where, for example, measurements can be utilized for calibration. The DRILLOPS framework provides flexibility to modify and replan activities dynamically, for example, based on a live appraisal of various factors (e.g., equipment, personnel, and supplies). Well construction activities (e.g., tripping, drilling, cementing, etc.) can be continually monitored and dynamically updated using feedback from operational activities. The DRILLOPS framework can provide for various levels of automation based on planning and/or re-planning (e.g., via the DRILLPLAN framework), feedback, etc.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (chemical EOR) formulations where such formulations can be implemented in the field, can analyze application of steam injection and other thermal FOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI environment on demand reservoir simulation features.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

While several simulators are illustrated in the example of FIG. 1, one or more other simulators may be utilized, additionally or alternatively. For example, consider the VISAGE geomechanics simulator (SLB, Houston Texas) or the PIPESIM network simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 disposal, etc. The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston, Texas).

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As an example, a model may be a simulated version of an environment, which may include one or more sites of possible emissions. As an example, a simulator may include features for simulating physical phenomena in an environment based at least in part on a model or models. A simulator, such as a weather simulator, can simulate fluid flow in an environment based at least in part on a model that can be generated via a framework that receives satellite data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model (e.g., of the Earth, the atmosphere, the oceans, etc.).

Phenomena associated with a sedimentary basin (e.g., a subsurface region, whether below a ground surface, water surface, etc.) may be modeled using various equations (e.g., stress, fluid flow, phase, etc.). As an example, a numerical model of a basin may find use for understanding various processes related to exploration and production of natural resources (e.g., estimating reserves in place, drilling wells, forecasting production, controlling fracturing, etc.).

For application of a numerical technique, equations may be discretized using nodes, cells, etc. For example, a numerical technique such as the finite difference method can include discretizing a differential heat equation for temperature with respect to a spatial coordinate or spatial coordinates to approximate temperature derivatives (e.g., first order, second order, etc.). While temperature is mentioned, the finite difference method can be utilized for one or more of various variables (e.g., pressure, fluid flow, stress, strain, etc.). Further, where time is of interest, a derivative of a variable or variables with respect to time may be provided.

Where a sedimentary basin (e.g., subsurface region) includes various types of features (e.g., stratigraphic layers, fractures, faults, etc.), nodes, cells, etc., may represent, or be assigned to, such features. In turn, discretized equations may better represent the sedimentary basin and its features. As an example, a structured grid that can represent a sedimentary basin and its features, when compared to an unstructured grid, may allow for more simulations runs, more model complexity, less computational resource demands, less computation time, etc. In various examples, a structured approach and/or an unstructured approach may be utilized.

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

As an example, seismic data may be acquired for a region in the form of traces. For example, acquisition equipment can emit energy from a source (e.g., a transmitter) and receive reflected energy via one or more sensors (e.g., receivers) strung along an inline direction. Where the region includes layers, energy emitted by a transmitter of the acquisition equipment can reflect off the layers. Evidence of such reflections may be found in the acquired traces.

A trace can be a series of data points from energy arriving at a receiver, for example, consider energy that arrives at a receiver where it is sensed and discretized by an analog-to-digital converter that operates at a sampling rate. For example, acquisition equipment may convert energy signals sensed by a receiver to digital samples at a rate of one sample per approximately 4 ms. Given a speed of sound in a medium or media (e.g., acoustic velocity), a sample rate may be converted to an approximate distance. For example, the speed of sound in rock may be of the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, the deepest boundary depth may be estimated to be about 10 km (e.g., assuming a speed of sound of about 5 km per second).

Digital images of a subsurface region of the Earth can be generated using digital seismic data (e.g., digital traces) acquired using reflection seismology as part of a seismic survey. A digital image can show subterranean structure, for example, as related to one or more of exploration for petroleum, natural gas, and mineral deposits. As an example, reflection seismology can include determining time intervals that elapse between initiation of a seismic wave at a selected shot point (e.g., the location where an explosion generates seismic waves) and the arrival of reflected or refracted impulses at one or more seismic detectors (e.g., sensing of seismic energy at one or more seismic receivers). As an example, a seismic air gun can be used to initiate seismic waves. As an example, one or more electric vibrators or falling weights (e.g., thumpers) may be employed at one or more sites. Upon arrival at the detectors, the amplitude and timing of seismic energy waves can be recorded, for example, as a seismogram (e.g., a record of ground vibrations).

In various regions of the Earth, the material density (e.g., rock density) increases with depth. Seismic energy waves can be initiated at a shot point (or points) at or near the surface where a portion of the seismic energy, as waves, may reach one or more receiving points. Material properties and structural organization of materials (e.g., as objects, layers, etc.) can affect seismic energy waves in one or more manners. Received seismic energy waves can be utilized to determine one or more types of material properties and/or structural organization of one or more types of materials. As with sound traveling through air or water, seismic energy waves can be attenuated as they pass through subsurface materials, which may include air, water, hydrocarbons, rock, etc. Such attenuation can occur in a manner that is dependent on material properties of such materials.

Interpretation of the depths and media reached by seismic energy waves can depend on geometry of a seismic survey, for example, on the distance between shot points and receiving points, as well as densities of media. Results of a seismic survey may be in digital form (e.g., digital data) as stored in memory of a computing device where display circuitry (e.g., a graphics processor, a video processor, etc.) can render the digital data to a display in the form of a cross-sectional image of subsurface structures (e.g., a slice) as if cut by a plane through the shot point, the detector, and a reference point such as the Earth's center. As an example, digital image processing can involve receiving seismic data as digital data, processing the seismic data via one or more techniques, and rendering processed seismic data to a display as an image of a region of the Earth that can show structural features of the Earth that otherwise are not visible from an observer standing on the surface of the Earth.

A seismic survey can be defined with respect to a region of the Earth and, for example, a manner of acquisition of seismic data. As an example, a survey may be two-dimensional, three-dimensional, four-dimensional, etc. Dimensions include one or more spatial dimensions and optionally one or more temporal dimensions (e.g., repeating a survey for a region at different points in time). As to a 2D survey, a grid may be considered dense if the line spacing (e.g., of receivers) is less than about 400 m. As to a 3D spatial survey, in comparison to a 2D spatial survey, it may help to elucidate true structural dip (e.g., a 2D survey may give apparent dip), it may provide more and better stratigraphic information, it may provide a map view of reservoir properties, it may provide a better areal mapping of fault patterns and connections and delineation of reservoir blocks, it may provide better lateral resolution (e.g., 2D may suffer from a cross-line smearing, or Fresnel zone, problem).

As to data sets, a 3D spatial seismic data set can be a cube or volume of data (e.g., a seismic cube or a seismic volume). As an example, a 2D spatial seismic data set can be a panel of data. To interpret 3D seismic data, a method can process the “interior” of the cube (e.g., a seismic cube) using one or more processors of computing equipment. As an example, a 3D seismic data set can range in size from a few tens of megabytes to several gigabytes or more.

As to a 3D seismic cube, a point can have an (x, y, z) coordinate and a data value. A coordinate can be a distance from a particular corner of the cube. A 3D seismic data volume is like a room-temperature example (e.g., where temperature differs in a cube shaped room), however, rather than a height of a room, a height or vertical axis can be in terms of a two-way traveltime (TWT), which may be a proxy for depth. In such an example, the 3D seismic cube is still a spatial cube because the data therein correspond to the same survey where, rather than depth, two-way traveltime (TWT) is utilized, which, can be, in general, a proxy for depth. And, in contrast to room-temperature, data values can be seismic amplitudes (e.g., amplitudes of seismic energy waves). A 3D seismic data set can be, for example, a box full of electronically determined numbers where each number represents a measurement (e.g., amplitude of a seismic energy wave, etc.). In a 3D seismic data set, amplitudes may be rendered as data values in the form of one or more images for slices through the 3D seismic data set where, for example, in grayscale, dark and light image bands in the sections are related to rock boundaries (e.g., interfaces between layers of rock).

Reflection seismology can be implemented as a technique that detects “edges” of materials in the Earth. An image generated utilizing reflection seismology can show such edges of materials, which can be equated to positions in the Earth such that one may know where an edge of a material is in the Earth. For example, where the edge corresponds to a hydrocarbon reservoir, a method can include drilling to the reservoir in a manner guided by the position of the edge. As an example, a drilling process can be manual, semi-automated or automated where positional information as to an edge of a material in the Earth can be utilized to guide drilling equipment that forms a bore in the Earth where the bore may be directed to the edge or to a region that is defined at least in part by the edge. Where reflection seismology is improved, such an “edge” may be detected more readily and/or with greater accuracy (e.g., resolution), which, in turn, can improve one or more field processes such as a drilling process.

As an example, a framework such as the PETREL framework may be utilized for processing seismic data for model generation where such a model may be a velocity model that defines layers of rock in a subsurface region. Such a model can serve as a basis for flow simulation, which may provide for indications of how fluids may be transported in the subsurface region (e.g., from a well to a reservoir, from a reservoir to a well, etc.). As an example, the DRILLPLAN framework can utilize seismic data-derived results for planning of one or more drilling operations, which, for example, may be executed in the field using field equipment controlled at least in part via the DRILLOPS framework. As explained, seismic data can be a basis for one or more workflows, which can include exploration, planning, drilling, production, etc. Where processing of seismic data can be improved, various workflows can also be improved (e.g., more accurate results, lesser time for results, etc.).

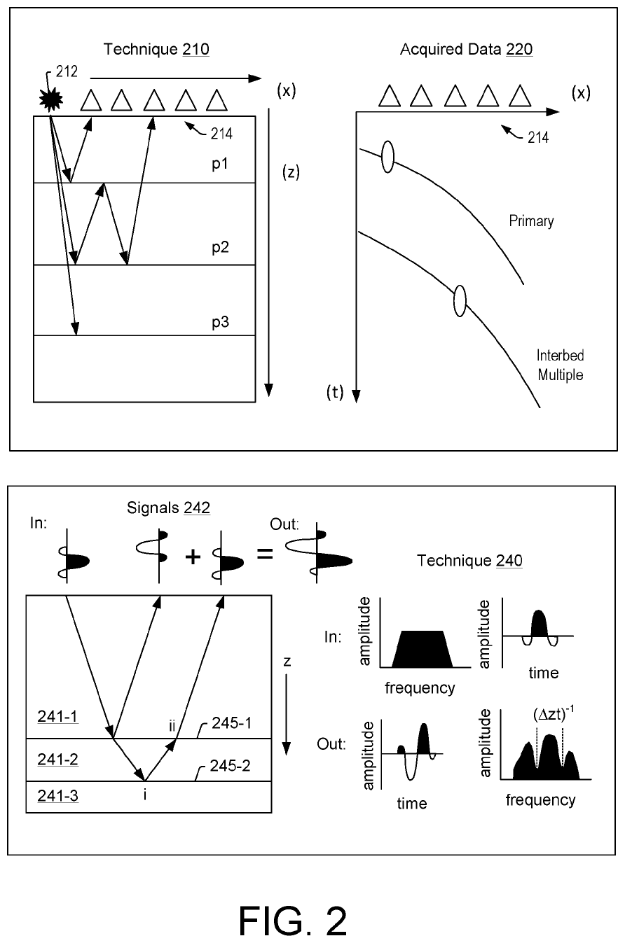

FIG. 2 shows an example of a technique 210 and acquired data 220, an example of a technique 240 and signals 242. As mentioned, a survey can include utilizing a source or sources and receivers. In the example technique 210, a source 212 is illustrated along with a plurality of receivers 214 that are spaced along a direction defined as an inline direction x. Along the inline direction x, distances can be determined between the source 212 and each of the receivers 214.

A subsurface region being surveyed includes features such a surface and subsurface horizons p1, p2 and p3 where one or more of such structural features can be interfaces where elastic properties (e.g., acoustic properties) can differ such that seismic energy is at least in part reflected. For example, a horizon can be an interface that might be represented by a seismic reflection, such as the contact between two bodies of rock having a difference in one or more of seismic velocity, density, porosity, fluid content, etc. In the example of FIG. 2, the technique 210 is shown to generate seismic reflections, which can include singly reflected and multiply reflected seismic energy. The acquired data 220 illustrate energy received by the receivers 214 with respect to time, t, and their inline position along the x-axis. As shown, singly reflected energy can be defined as primary (or primaries) while multiply reflected energy can be defined as multiples such as surface multiples, interbed multiples (e.g., IM), etc.

A primary can be defined as a seismic event whose energy has been reflected once; whereas, a multiple can be defined as an event whose energy has been reflected more than once. With respect to seismic interpretation, whether manual, semi-automatic or automatic, various techniques may aim to enhance primary reflections to facilitate interpretation of one or more subsurface interfaces. In other words, multiples can be viewed as extraneous signal or noise that can interfere with an interpretation process. As an example, one or more method can utilize multiples to provide useful signals. For example, consider a seismic survey designed to increase seismic signal coverage of a subsurface region of the Earth through use of multiples.

In FIG. 2, the technique 240 can include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

A wavelet can be a one-dimensional pulse defined by attributes such as, for example, amplitude, frequency and phase. A wavelet can originate as a packet of energy from a source point, having a specific origin in time, and be returned to one or more receivers as a series of events distributed in time and energy. The distribution is a function of velocity and density changes in the subsurface and the relative position of the source and receiver. Energy that returns cannot exceed what was input, so the energy in a received wavelet decays with time, for example, as more partitioning takes place at interfaces. Wavelets can also decay due to loss of energy as heat during propagation, which can be more extensive at higher frequencies. In various instances, received wavelets tend to contain less high-frequency energy relative to low frequencies at longer traveltimes. Some wavelets are known by their shape and spectral content, such as the Ricker wavelet (e.g., a zero-phase wavelet such as the second derivative of the Gaussian function or the third derivative of the normal-probability density function).

As an example, a geologic environment may include layers 241-1, 241-2 and 241-3 where an interface 245-1 exists between the layers 241-1 and 241-2 and where an interface 245-2 exists between the layers 241-2 and 241-3. As illustrated in FIG. 2, a wavelet may be first transmitted downward in the layer 241-1; be, in part, reflected upward by the interface 245-1 and transmitted upward in the layer 241-1; be, in part, transmitted through the interface 245-1 and transmitted downward in the layer 241-2; be, in part, reflected upward by the interface 245-2 (see, e.g., “i”) and transmitted upward in the layer 241-2; and be, in part, transmitted through the interface 245-1 (see, e.g., “ii”) and again transmitted in the layer 241-1. In such an example, signals (see, e.g., the signals 262) may be received as a result of wavelet reflection from the interface 245-1 and as a result of wavelet reflection from the interface 245-2. These signals may be shifted in time and in polarity such that addition of these signals results in a waveform that may be analyzed to derive some information as to one or more characteristics of the layer 241-2 (e.g., and/or one or more of the interfaces 245-1 and 245-2). For example, a Fourier transform of signals may provide information in a frequency domain that can be used to estimate a temporal thickness (e.g., Azt) of the layer 241-2 (e.g., as related to acoustic impedance, reflectivity, etc.).

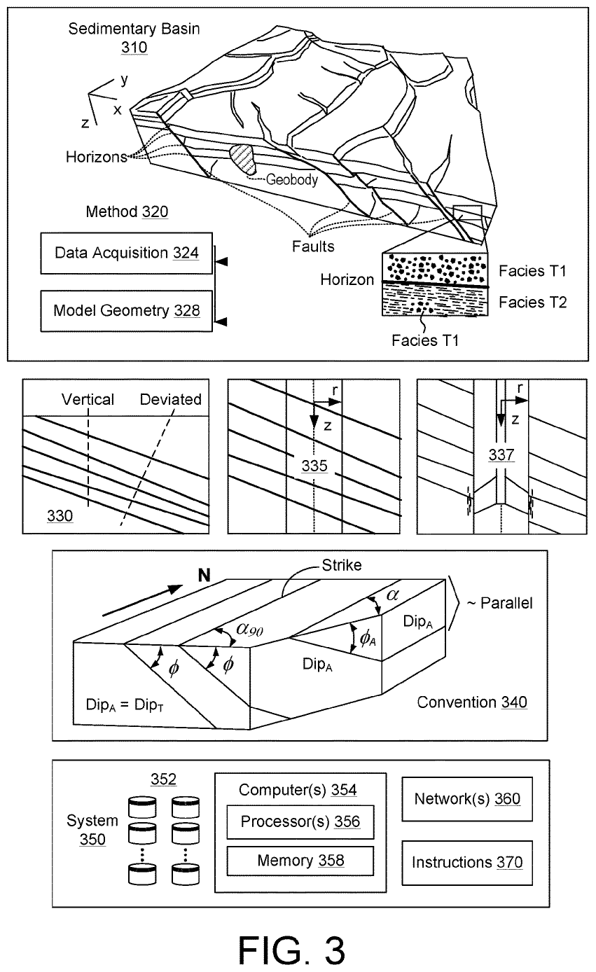

FIG. 3 shows an example of a sedimentary basin 310 (e.g., a geologic environment), an example of a method 320 for model building (e.g., for a simulator, etc.), an example of a formation 330, an example of a borehole 335 in a formation, an example of a convention 340 and an example of a system 350.

As an example, data acquisition, reservoir simulation, petroleum systems modeling, etc. may be applied to characterize various types of subsurface environments, including environments such as those of FIG. 1.

In FIG. 3, the sedimentary basin 310, which is a geologic environment, includes horizons, faults, one or more geobodies and facies formed over some period of geologic time. These features are distributed in two or three dimensions in space, for example, with respect to a Cartesian coordinate system (e.g., x, y and z) or other coordinate system (e.g., cylindrical, spherical, etc.). As shown, the model building method 320 includes a data acquisition block 324 and a model geometry block 328. Some data may be involved in building an initial model and, thereafter, the model may optionally be updated in response to model output, changes in time, physical phenomena, additional data, etc. As an example, data for modeling may include one or more of the following: depth or thickness maps and fault geometries and timing from seismic, remote-sensing, electromagnetic, gravity, outcrop and well log data. Furthermore, data may include depth and thickness maps stemming from facies variations (e.g., due to seismic unconformities) assumed to following geological events (“iso” times) and data may include lateral facies variations (e.g., due to lateral variation in sedimentation characteristics).

As shown in FIG. 3, the formation 330 includes a horizontal surface and various subsurface layers. As an example, a borehole may include a vertical portion, a deviated portion, a curved portion, etc. For relatively thin and laterally extensive reservoirs, directional drilling may aim to generate a borehole that extends laterally within such a reservoir, for example, to increase reservoir contact of a borehole to provide for improved reservoir drainage (e.g., hydrocarbon production). In such an example, knowing the upper and lower bounds of the reservoir, which may vary spatially, can facilitate planning, drilling and production. As explained, seismic data can provide a basis for determining extents of such reservoir boundaries (e.g., upper bound and lower bound).

In the example of FIG. 3, the borehole 335 may be considered a vertical borehole, for example, where the z-axis extends downwardly normal to the horizontal surface of the formation 330. As an example, a tool 337 may be positioned in a borehole, for example, to acquire information. As mentioned, a borehole tool may be configured to acquire electrical borehole images. As an example, the fullbore Formation MicroImager (FMI) tool (SLB, Houston, Texas) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

As an example, one or more probes may be deployed in a bore via a wireline or wirelines. As an example, a probe may emit energy and receive energy where such energy may be analyzed to help determine mineral composition of rock surrounding a bore, which may provide for identification of layer boundaries, etc.

As an example, a tool may be positioned to acquire information in a horizontal portion of a borehole. Analysis of such information may reveal vugs, dissolution planes (e.g., dissolution along bedding planes), stress-related features, dip events, etc. As an example, a tool may acquire information that may help to characterize a fractured reservoir, optionally where fractures may be natural and/or artificial (e.g., hydraulic fractures). Such information may assist with completions, stimulation treatment, etc. As an example, information acquired by a tool may be analyzed using a framework such as the TECHLOG framework (SLB, Houston, Texas).

As an example, data acquired through use of one or more borehole tools (e.g., downhole tools) may provide a basis for identifying rock layers, interfaces, formation tops, etc. Such data may assist with processing of seismic data. For example, where a borehole is present and the position of an interface known at a depth of the borehole, that knowledge may be tied to a reflector evidenced in seismic data, which may help to identify an extent of the reflector (e.g., a horizon). As explained, rather than providing a single point in space for a reflector (e.g., as with various types of borehole data), a seismic survey can provide a set of multidimensional points in space for a reflector. As explained, a reflector may be a boundary such as, for example, a reservoir boundary, where drilling operations can aim to drill a borehole into the reservoir based on knowledge of one or more reservoir boundaries.

As to the convention 340 for dip, as shown in FIG. 3, the three-dimensional orientation of a plane can be defined by its dip and strike, which can be considered to be types of orientation information (e.g., structural orientation information). Dip is the angle of slope of a plane from a horizontal plane (e.g., an imaginary plane) measured in a vertical plane in a specific direction. Dip may be defined by magnitude (e.g., also known as angle or amount) and azimuth (e.g., also known as direction). As shown in the convention 340 of FIG. 3, various angles φ indicate angle of slope downwards, for example, from an imaginary horizontal plane (e.g., flat upper surface); whereas, dip refers to the direction towards which a dipping plane slopes (e.g., which may be given with respect to degrees, compass directions, etc.). Another feature shown in the convention of FIG. 3 is strike, which is the orientation of the line created by the intersection of a dipping plane and a horizontal plane (e.g., consider the flat upper surface as being an imaginary horizontal plane).

Some additional terms related to dip and strike may apply to an analysis, for example, depending on circumstances, orientation of collected data, etc. One term is “true dip” (see, e.g., Dip_{T} in the convention 340 of FIG. 3). True dip is the dip of a plane measured directly perpendicular to strike (see, e.g., line directed northwardly and labeled “strike” and angle ago) and also the maximum possible value of dip magnitude. Another term is “apparent dip” (see, e.g., Dip_{A} in the convention 340 of FIG. 3). Apparent dip may be the dip of a plane as measured in any other direction except in the direction of true dip (see, e.g., φ_{A} as Dip_{A} for angle α); however, it is possible that the apparent dip is equal to the true dip (see, e.g., φ as Dip_{A}=Dip_{T} for angle ago with respect to the strike). In other words, where the term apparent dip is used (e.g., in a method, analysis, algorithm, etc.), for a particular dipping plane, a value for “apparent dip” may be equivalent to the true dip of that particular dipping plane.

As shown in the convention 340 of FIG. 3, the dip of a plane as seen in a cross-section perpendicular to the strike is true dip (see, e.g., the surface with φ as Dip_{A}=Dip_{T} for angle α₉₀ with respect to the strike). As indicated, dip observed in a cross-section in any other direction is apparent dip (see, e.g., surfaces labeled Dip_{A}). Further, as shown in the convention 340 of FIG. 3, apparent dip may be approximately 0 degrees (e.g., parallel to a horizontal surface where an edge of a cutting plane runs along a strike direction).

In terms of observing dip in wellbores, true dip is observed in wells drilled vertically. In wells drilled in any other orientation (or deviation), the dips observed are apparent dips (e.g., which are referred to by some as relative dips). In order to determine true dip values for planes observed in such boreholes, as an example, a vector computation (e.g., based on the borehole deviation and borehole azimuth) may be applied to one or more apparent dip values.

As mentioned, another term that finds use in sedimentological interpretations from borehole images is “relative dip” (e.g., DipR). A value of true dip measured from borehole images in rocks deposited in very calm environments may be subtracted (e.g., using vector-subtraction) from dips in a sand body. In such an example, the resulting dips are called relative dips and may find use in interpreting sand body orientation.

A convention such as the convention 340 may be used with respect to an analysis, an interpretation, an attribute, etc. (e.g., consider a PETREL seismic-to-simulation framework workflow, etc.). As an example, various types of features may be described, in part, by dip (e.g., sedimentary bedding, faults and fractures, cuestas, igneous dikes and sills, metamorphic foliation, etc.). As an example, dip may change spatially as a layer approaches a geobody. For example, consider a salt body that may rise due to various forces (e.g., buoyancy, etc.). In such an example, dip may trend upward as a salt body moves upward.

Seismic interpretation may aim to identify and/or classify one or more subsurface boundaries based at least in part on one or more dip parameters (e.g., angle or magnitude, azimuth, etc.). As an example, various types of features (e.g., sedimentary bedding, faults and fractures, cuestas, igneous dikes and sills, metamorphic foliation, etc.) may be described at least in part by angle, at least in part by azimuth, etc.

As shown in FIG. 3, the system 350 includes one or more information storage devices 352, one or more computers 354, one or more networks 360 and one or more sets of instructions 370. As to the one or more computers 354, each computer may include one or more processors (e.g., or processing cores) 356 and memory 358 for storing instructions, for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 352.

As an example, the one or more sets of instructions 370 may include instructions stored in memory and accessible to one or more of the one or more processors 356 in a manner that allows for execution thereof by such of one or more processors 356 to instruct the system 350 to perform various actions. As an example, the system 350 may be configured such that the one or more sets of instructions 370 provide for establishing the framework or a portion thereof. As an example, one or more methods, techniques, etc. may be performed using one or more sets of instructions, which may be, for example, one or more of the one or more sets of instructions 370 of FIG. 3.

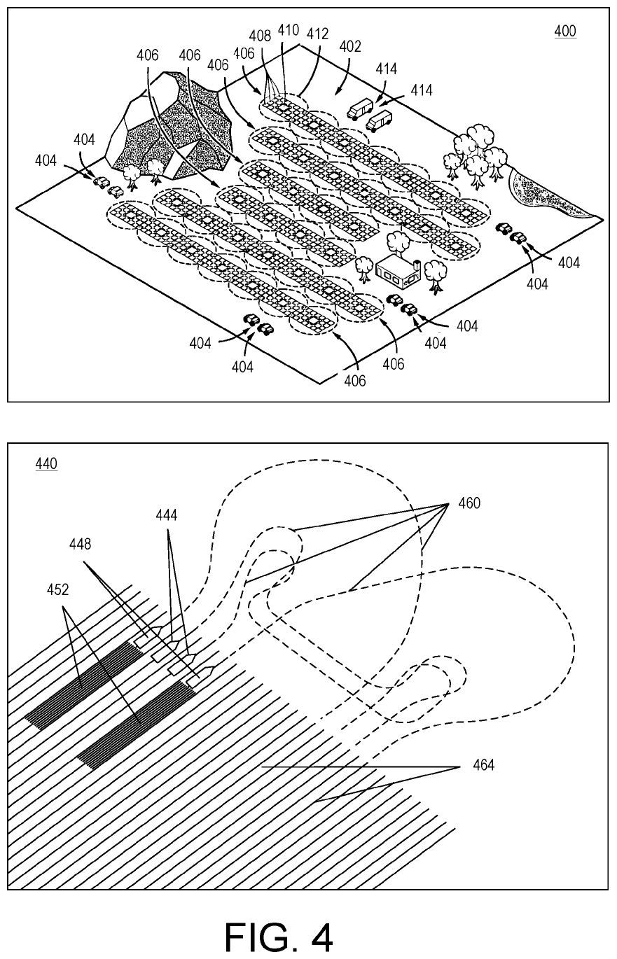

FIG. 4 shows an example of a simplified schematic view of a land seismic data acquisition system 400 and an example of a simplified schematic view of a marine seismic data acquisition system 440.

As shown with respect to the system 400, an area 402 to be surveyed may or may not have physical impediments to direct wireless communication between a recording station 414 (which may be a recording truck) and a vibrator 404. A plurality of vibrators 404 may be employed, as well as a plurality of sensor unit grids 406, each of which may have a plurality of sensor units 408.

As illustrated in FIG. 4 with respect to the system 400, approximately 24 to about 28 sensor units 408 may be placed in a vicinity (a region) around a base station 410. The number of sensor units 408 associated with each base station 410 may vary from survey to survey. Circles 412 indicate an approximate range of reception for each base station 410.

In the system 400 of FIG. 4, the plurality of sensor units 408 may be employed in acquiring and/or monitoring land-seismic sensor data for the area 402 and transmitting the data to the one or more base stations 410. Communications between the vibrators 404, the base stations 410, the recording station 414, and the seismic sensors 408 may be wireless (at least in part via air for a land-based system; or optionally at least in part via water for a sea-based system).

In the system 440 of FIG. 4, one or more source vessels 440 may be utilized with one or more streamer vessels 448 or a vessel or vessels may tow both a source or sources and a streamer or streamers 452. In the example of FIG. 4, the vessels 444 and 448 (e.g., or just the vessels 448 if they include sources) may follow predefined routes (e.g., paths) for an acquisition geometry that includes inline and crossline dimensions. As shown, routes 460 can be for maneuvering the vessels to positions 464 as part of the survey. As an example, a marine seismic survey may call for acquiring seismic data during a turn (e.g., during one or more of the routes 460).

The example systems 400 and 440 of FIG. 4 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime (TWT)).

Two-way traveltime (TWT) can be defined as the elapsed time for a seismic wave to travel from its source to a given reflector and return to a receiver (e.g., at a surface, etc.). As an example, a minimum two-way traveltime (TWTₘᵢₙ) can be defined to be that of a normal-incidence wave with zero offset.

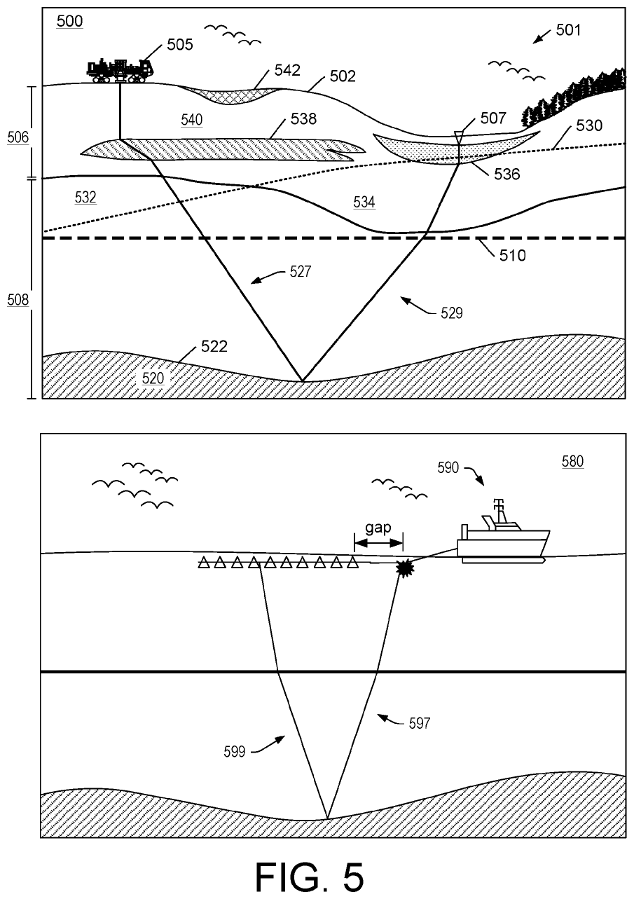

FIG. 5 shows an example of a land system 500 and an example of a marine system 580. The land system 500 is shown in a geologic environment 501 that includes a surface 502, a source 505 at the surface 502, a near-surface zone 506, a receiver 507, a bedrock zone 508 and a datum 510 where the near-surface zone 506 (e.g., near-surface region) may be defined at least in part by the datum 510, which may be a depth or layer or surface at which data above are handled differently than data below. For example, a method can include processing seismic data that aims to “place” the source 505 and the receiver 507 on a datum plane defined by the datum 510 by adjusting (e.g., “correcting”) traveltimes for propagation through the near-surface region (e.g., a shallower subsurface region).

In the example system 500 of FIG. 5, the geologic environment 501 can include various features such as, for example, a layer 520 that defines an interface 522 that can be a reflector, a water table 530, a leached zone 532, a glacial scour 534, a buried river channel 536, a region of material 538 (e.g., ice, evaporates, volcanics, etc.), a high velocity zone 540, and a region of material 542 (e.g., Eolian or peat deposits, etc.).

In FIG. 5, the land system 500 is shown with respect to downgoing rays 527 (e.g., downgoing seismic energy) and upgoing rays 529 (e.g., upgoing seismic energy). As illustrated the rays 527 and 529 pass through various types of materials and/or reflect off of various types of materials.

Various types of seismic surveys can contend with surface unevenness and/or near-surface heterogeneity. For example, a shallow subsurface can include large and abrupt vertical and horizontal variations that may be, for example, caused by differences in lithology, compaction cementation, weather, etc. Such variations can generate delays or advances in arrival times of seismic waves passing through them relative to waves that do not. By accounting for such time differences, a seismic image may be of enhanced resolution with a reduction in false structural anomalies at depth, a reduction in mis-ties between intersecting lines, a reduction in artificial events created from noise, etc.

In FIG. 5, the datum 510 is shown, for example, as a plane, below which strata may be of particular interest in a seismic imaging workflow. In a three-dimensional model of a geologic environment, a near surface region may be defined, for example, at least in part with respect to a datum. As an example, a velocity model may be a multidimensional model that models at least a portion of a geologic environment.

In the example of FIG. 5, the source 505 can be a seismic energy source such as a vibrator. As an example, a vibrator may be a mechanical source that delivers vibratory seismic energy to the Earth for acquisition of seismic data. As an example, a vibrator may be mounted on a vehicle (e.g., a truck, etc.). As an example, a seismic source or seismic energy source may be one or more types of devices that can generate seismic energy (e.g., an air gun, an explosive charge, a vibrator, etc.).

As an example, a sensor unit can include a geophone, which may be configured to detect motion in a single direction. As an example, a geophone may be configured to detect motion in a vertical direction. As an example, three mutually orthogonal geophones may be used in combination to collect so-called 3C seismic data. As an example, a sensor unit that can acquire 3C seismic data may allow for determination of type of wave and its direction of propagation. As an example, a sensor assembly or sensor unit may include circuitry that can output samples at intervals of 1 ms, 2 ms, 4 ms, etc. As an example, an assembly or sensor unit can include an analog-to-digital converter (ADC) such as, for example, a 24-bit sigma-delta ADC (e.g., as part of a geophone or operatively coupled to one or more geophones). As an example, a sensor assembly or sensor unit can include synchronization circuitry such as, for example, GPS synchronization circuitry with an accuracy of about plus or minus 12.5 microseconds. As an example, an assembly or sensor unit can include circuitry for sensing of real-time and optionally continuous tilt, temperature, humidity, leakage, etc. As an example, an assembly or sensor unit can include calibration circuitry, which may be self-calibration circuitry.

In FIG. 5, the system 580 includes equipment 590, which can be a vessel that tows one or more sources and one or more streamers (e.g., with receivers). In the system 580, a source of the equipment 590 can emit energy at a location and a receiver of the equipment 590 can receive energy at a location. The emitted energy can be at least in part along a path of the downgoing energy 597 and the received energy can be at least in part along a path of the upgoing energy 599.

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

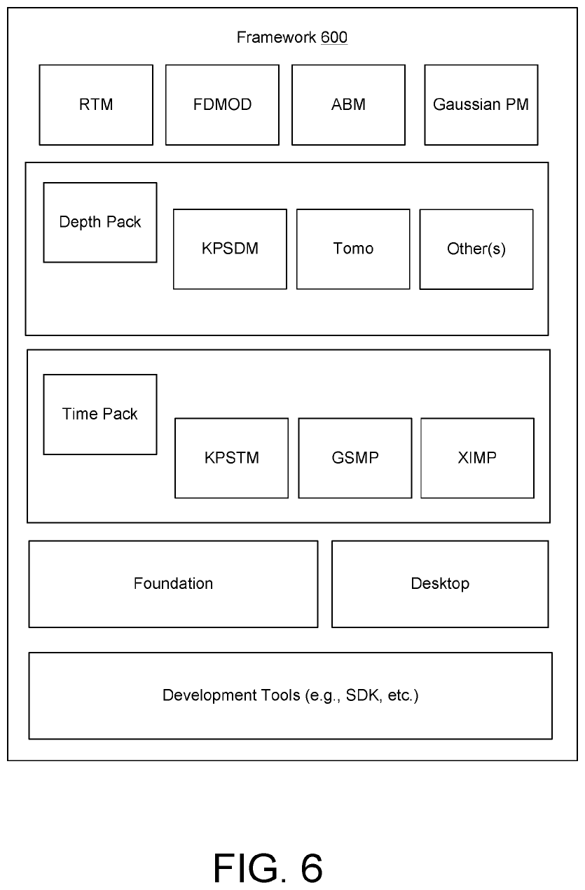

FIG. 6 shows an example of a computational framework 600 that can include one or more processors and memory, as well as, for example, one or more interfaces. The blocks of the computational framework 600 may be provided as instructions such as the instructions 370 of the system 350 of FIG. 3. The computational framework of FIG. 6 can include one or more features of the OMEGA framework (SLB, Houston, Texas), which may be a framework operable with a system such as the system 100 of FIG. 1. The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 6, the computational framework 600 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 600 can include features for geophysics data processing. The framework 600 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 600 can allow for transforming seismic, electromagnetic, microseismic, and/or vertical seismic profile (VSP) data into actionable information, for example, to perform one or more actions in the field for purposes of resource production, etc. The framework 600 can extend workflows into reservoir characterization and earth modelling. For example, the framework 600 can extend geophysics data processing into reservoir modelling by integrating with the DELFI environment and/or the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with the framework's depth tomography and migration algorithms, can produce accurate and precise images of the subsurface. The framework 600 may provide support for field to final imaging, to prestack seismic interpretation and quantitative interpretation, from exploration to development.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As explained, various types of workflows can utilize seismic data. Such workflows may utilize one or more types of frameworks (e.g., the OMEGA framework, the PETREL framework, etc.). As an example, seismic data may be processed to generate one or more types of seismic attributes. For example, consider seismic dip as a seismic attribute that may be generated using a dip estimation technique.

A dip field is a measurement of the angle of formations and may be derived from seismic data. As an example, a process can generate a dip field by analyzing shifts in correlation for a moving window through a seismic volume. Dip fields can be used for one or more purposes, for example, to compute curvature, dip azimuth, as input to perform computations guided by structure, etc. As an example, dip values may be measured in a vertical dimension (e.g., time or depth) and/or in a horizontal dimension (e.g., milliseconds/inline (IL), milliseconds/crossline (CL or XL), etc.). For example, if a dip field is computed from a volume in depth, then the units of apparent dip can be meters/IL; whereas, if a dip field is computed from a volume in time, then the units of apparent dip can be milliseconds/IL. The apparent dip values can be per single IL or CL, regardless of the increment of the dip field. A technique may involve converting dip to m/m or ms/m using the IL and CL spacings from a 3D seismic survey.

As an example, a dip estimation technique may be applied separately in the inline (IL) and crossline (CL) directions. In such an example, a dip field (e.g., dip estimation seismic attribute) may be specified using IL and CL values, as may be defined using a grid. As another example, a dip estimation technique may be applied to generate a maximum dip that is specified along with the azimuth of the maximum dip. As an example, azimuth may be specified as an angle that characterizes a direction or vector relative to a reference direction (e.g., magnetic north, grid north, etc.) on a horizontal plane where azimuth may be, for example, in degrees (e.g., from 0 to 359). As an example, where maximum dip and azimuth are specified, dip may be converted into vector components such as IL dip and CL dip, noting that axes other than IL and CL may be utilized.

As an example, a flow field may be generated using seismic data. For example, consider a method that includes generating ordered seismic images or “slices” from a seismic cube in an inline (IL) direction and a crossline (CL) direction. In such an example, the slices can generally be parallel to one another and offset by some distance from one another where, for example, the distance may vary depending on constraints such as memory, seismic resolution, etc. Such slices can be “ordered” in the sense that, in a cube, the slices are positioned sequentially along an axis, and may be numbered sequentially. In such an approach, differences between pixel locations in adjacent slices can be define a flow field. For example, slices along in an inline axis, with a difference between adjacent slices, can define at least a portion of a flow field. A flow field may be considered to be a type of seismic attribute that is derived from seismic data. A flow field can provide dip information and therefore may be a type of dip estimate. As explained, various seismic attributes can be defined using multiple values or multiple sets of values. For example, dip estimate and/or flow field can be defined using IL and CL values where an IL axis is generally orthogonal to a CL axis.

An article by Zhun Li and Aria Abubakar, (2020), “Complete sequence stratigraphy from seismic optical flow without human labeling,” SEG Technical Program Expanded Abstracts: 1248-1252, is incorporated by reference herein in its entirety. The article by Li and Abubakar describes seismic FlowNet training with an inference solution where a flow field can be obtained between each pair of adjacent seismic traces. If a flow field is accurate, sampling a first seismic trace according to the flow field can output a warped seismic trace that matches a second seismic trace adjacent to the first seismic trace.

A U.S. Patent Application having Ser. No. 17/248,259, entitled “Seismic interpretation using flow fields”, published as US Pub. No. 2021/0223428 A1 on 22 Jul. 2021 and issued as U.S. Pat. No. 11,531,131 B2, is incorporated by reference herein in its entirety (referred to herein as the '131 patent). A U.S. Provisional Patent Application having Ser. No. 62/961,881, filed on 16 Jan. 2020, is also incorporated by reference herein in its entirety.

As an example, two-dimensional seismic images can be generated using seismic data where a technique can be applied to generate flow fields for pairs of the seismic images using a machine learning (ML) model, as explained in the article by Li and Abubakar and the '131 patent. In some embodiments, flow fields may be defined for each adjacent pair of seismic images (such that there may be N−1 flow fields, produced for N seismic images). Flow fields may be ordered, for example, with a first flow field corresponding to the first and second slices, etc. As to the ML model, as an example, it may be a convolution network. For example, consider an ML model with an encoder-decoder architecture. Such an ML model may be trained to produce (e.g., single channel) flow fields for each of (or any subset of) pairs of seismic images (e.g., pixel images). As an example, generated flow fields may each be a 2D image, for example, with the same size as input seismic slices.

By way of explanation, flow fields can represent a dense pixel-to-pixel correspondence between two consecutive “frames”, generally in video imagery, and in this case, considering the seismic slices as the frames and the seismic cube as the video. A given flow field may thus provide a 2-D vector at each pixel location of a frame, representing the instantaneous motion of pixels from one frame to the next frame. By tracking optical flow, the location of a pixel in a first frame (or, the location of the object partially represented in the pixel) can be determined for a second frame. In general, optical flow can be used to track the motion of a particular point when moving through the frames. The corresponding optical flow field represents the pixel-wise movement speed and direction from one frame to the next. Similarly, the flow field between two adjacent slices of seismic survey can indicate pixel-wise movement of the sediments from one slice to the next.

As an example, given a seismic attribute, a workflow can involve generating horizons using relative geological time (RGT) (e.g., in three dimensions). In such an example, the workflow may involve tracking from a seed trace. For example, a seed trace may have RGT values assigned to each voxel of the trace itself. The RGT value may be the index (e.g., the order in which the voxel appears in a particular axis, relative to the other voxels of the trace) of each voxel. As an example, the RGT value of one of the adjacent traces of the seed trace can be obtained by interpolating the seed trace RGT based on the flow field between seed trace and the adjacent trace. Then the RGT value for the other traces in a seismic survey may then computed according to a flood fill technique (e.g., in the context of horizon (or other object) tracking).

In various instances, moving from a seismic attribute to horizons can be challenging. For example, a technique may impart various types of inaccuracies, which can include artefact type of inaccuracies that may be inherent in the technique itself, the nature of how a seismic attribute is determined and/or how a seismic survey is performed. As explained, a seismic survey can be grid-based using a grid defined by IL and CL axes where a seismic volume may retain such grid characteristics (e.g., consider x and y axes). As explained, various seismic attributes can be defined using IL and CL or x and y axes, or converted thereto. As an example, use of a grid may help to expedite processing as computations may be performed along a dimension and as memory may store values in an array. In the aforementioned FlowNet approach, artefacts may be present such as, for example, an “X” artefact, as explained in further detail below.

As an example, a workflow may implement a process known as seismic flattening that aims to map a seismic volume from its original space in depth (e.g., or two-way traveltime (TWT)) to a so-called Wheeler domain in geologic time where seismic reflections are horizontally aligned. A Wheeler diagram can be a type of stratigraphic summary chart on which geologic time is plotted as the vertical scale, and distance across the area of interest as the horizontal scale, and on which a variety of stratigraphic information can be collated, for example, to provides an efficient way to interpret a volume of horizons at once. A workflow can include extracting horizontal slices in a flattened space to provide for Wheeler diagram and/or other stratigraphic analyses.

Various slope-based flattening techniques that can locally flatten seismic reflections, however, often fail to flatten the reflections in a global sense and therefore encounter alignment issues for reflections that span across one or more faults. Some techniques can be iterative, which may aim to improve the flattening by using the slopes and correlations of seismic traces. For example, local slopes, estimated for each image sample, can locally follow reflections but may fail to track the reflections over a long distance or correlate the reflections across one or more faults. In such an approach, seismic correlations, computed for randomly and sparsely extracted seismic traces, may help to align the corresponding reflections over a long distance and across faults and provide for computing a relative geologic time (RGT) volume that implicitly includes structure information of a seismic volume. Such an approach may aim to extract an arbitrary number of horizons as isosurfaces of RGT values.

As an example, a seismic interpretation workflow may utilize a so-called flow field technique to track a horizon and relative geological time (RGT) or another time and/or depth. In such an approach, a 3D RGT volume can be generated from two 3D flow fields which follow along inline (IL) and crossline (CL) directions respectively. A flood fill searching regime can be employed to track RGT traces starting from a seed RGT trace. During this process, a new RGT trace is obtained by linearly sampling its adjacent seed RGT according to the flow field between the two traces. This technique can provide an accurate RGT if accurate flow fields are provided. A so-called loop-tie constraint can also be satisfied if accurate flow fields are provided. Under the loop-tie constraint, the same horizon will be tracked starting from a given seed point located on the horizon. However, in practice the flow field has some amount of error such that error accumulation occurs as a trace becomes farther away from a seed trace. Combined with the fact that for majority of cases a flow field will not completely satisfy loop-tie constraint due to small error, an “X” shape alias (e.g., artefact) can appear on a horizon tracked with a flow field technique using a flood-fill regime. Compared to a region in a tracked 3D RGT that is close to a seed RGT trace, flow fields may be poorly followed in a region farther away from the seed trace. This results in the phenomena that the farther away from the seed trace, an “X” shape alias becomes more prominent.

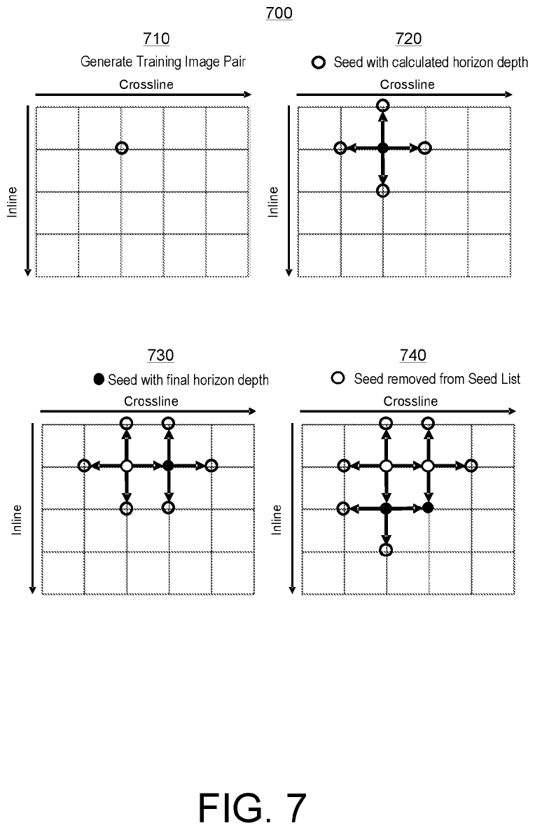

FIG. 7 shows an example of a technique 700 for 3D horizon tracking using flood fill. As shown in FIG. 7, in a graphic 710, a seed trace is selected with assigned RGT value; in a graphic 720, the RGT of the 4 neighbor traces of the seed trace is sampled based on the corresponding flow fields; in a graphic 730, starting from one of the 4 neighbor traces, the RGT value of its remaining 3 neighbor traces is sampled; and, in a graphic 740, when the RGT value of a trace is sampled from two different neighbors, the average of the two sampled RGT values can be taken. Such a process can be repeated until desired traces from a seismic survey are tracked.

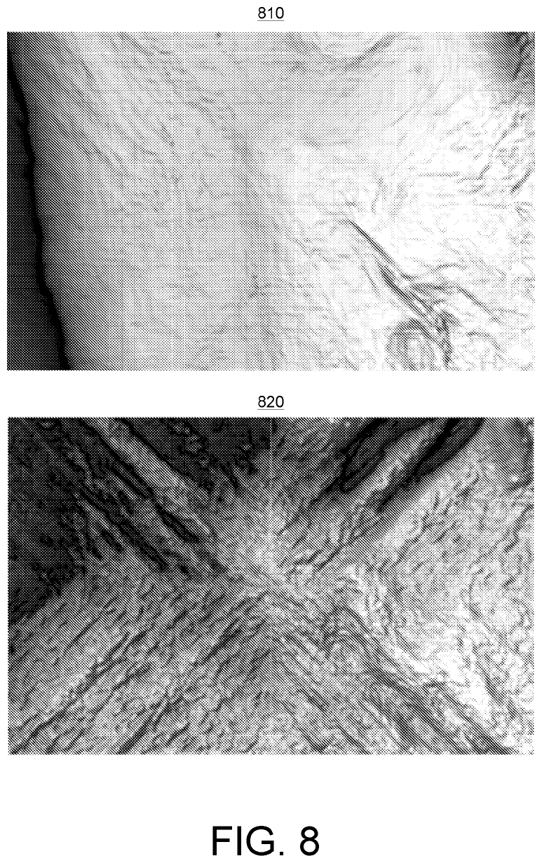

FIG. 8 shows horizon images 810 and 820 that include an “X” shape alias (e.g., artefact), which can be more pronounced further from a seed point (e.g., as the edges in the images). As explained, an “X” shape alias can appear on horizons extracted from a flow field or RGT.

As an example, a method can include using one or more machine learning (ML) techniques such as, for example, neural network training, as an optimization technique to refine relative geological time (RGT) based on a flow field or another seismic attribute (e.g., dip field, etc.). Such a method can reduce artefacts such as the aforementioned “X” shape alias. By reducing artefacts, output from a seismic data workflow can be improved. For example, a boundary of a reservoir may be improved, a model may be improved, etc.

As an example, a workflow can include generating a seismic attribute using seismic data and tracking a horizon based on the seismic attribute through use of a ML model. In such an example, the seismic attribute may be utilized as input to the ML model where RGT values may be training variables of the ML model. In such an approach, by training the ML model, appropriate RGT values may be determined where such RGT values may be optimized RGT values (e.g., based on a loss function, etc.). In such an approach, the ML model may be trained in an unsupervised manner for a particular subsurface region based on seismic attribute values (e.g., a seismic attribute volume or cube). As explained, a seismic attribute may be defined or definable along two axes such as x and y axes or IL and CL axes. As an example, an ML model may be an interpolation type of model and may be neural network-based. As an example, such an approach may be integrated into a framework such as, for example, the PETREL framework, the OMEGA framework, a FlowNet framework, etc.

Referring again to the “X” shape alias, as an example, to remediate error accumulation and the “X” shape alias, an optimization technique can be implemented through the training of one or more ML models (e.g., neural network, etc.) to help ensure that a flow field (e.g., or other seismic attribute) is more evenly followed by a resulting RGT, no matter if it is far away from or close to a seed RGT trace. In various instances, a seed may be selected with reference to one or more other types of data. For example, as explained, borehole data may provide a point of reference as to an interface (e.g., a horizon) in a subsurface region (e.g., subsurface space). As an example, a gridded implementation of an optimization technique can reduce computing demands (e.g., time, resources, cost, etc.) and provide a viable solution for an interpretation workflow, which may aim to build a model of a subsurface region that is suitable for use by one or more simulators, for inversion, for planning, for field operations, etc. In various trials, the “X” shape alias is reduced substantially after application of such an optimization technique.

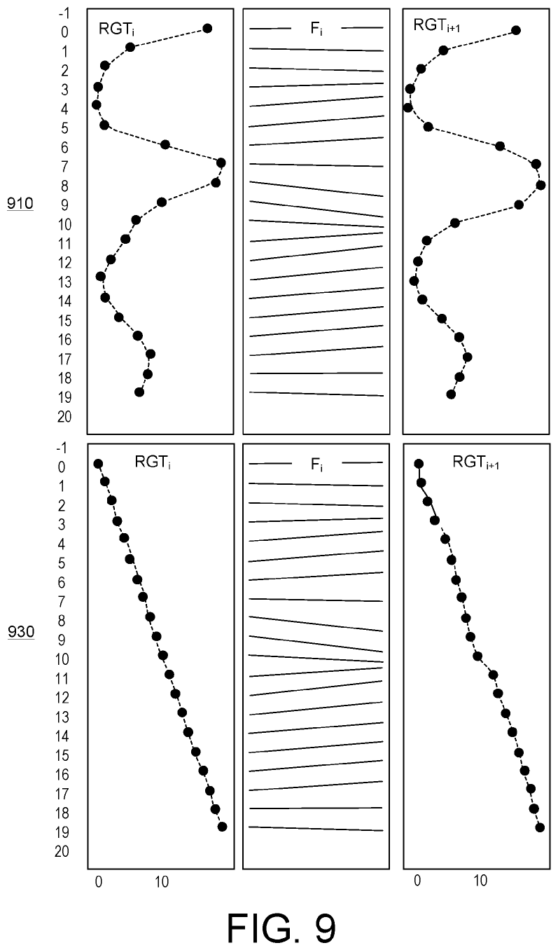

FIG. 9 shows graphics 910 and 930 of flow field and RGT examples. In the graphics 910, the left and right graphics are two adjacent seismic traces (e.g., after stacking, post-stack, etc.) while the center graphic is the flow field (Fᵢ) between the two adjacent seismic traces (RGTᵢ and RGTᵢ₊₁). As shown, a seismic trace can be represented as amplitude (horizontal axis) with respect to depth or time (vertical axis). At a time or a depth indicated as 7 (e.g., from −1 to 20), the flow field is constant with respect to distance between the two seismic traces (e.g., a horizontal horizon without dip, etc.). An accurate flow field can provide the exact pixel-wise displacement of seismic horizons between the two adjacent seismic traces.

As shown in FIG. 9, a new RGT trace can be tracked by linearly sampling an existing RGT trace. The graphics 930 show an example of tracking an RGT trace from a seed RGT trace, where the left graphic is a seed RGT trace (RGTᵢ) and the right graphic is an adjacent RGT trace (RGTᵢ₊₁) to be obtained while the center graphic is the flow field (Fᵢ) between the two RGT traces. Akin to the relationship between the seismic traces and the flow field of the graphics 910, the RGT and flow field relationship can satisfy the following: sampling the seed RGT trace according to a flow field can provide for an RGT trace that matches an RGT trace adjacent to the seed RGT trace. This linear sampling relationship can form the foundation of an RGT optimization algorithm.

The graphics 930 can be utilized to illustrate an example of an RGT optimization process. Let the left RGT trace represent RGTᵢ, while the right RGT trace represents RGTᵢ₊₁ and the center graphic represents the flow field Fᵢ between RGTᵢ and RGTᵢ₊₁. In such an example, a framework can denote the linear sampling operation as S(F, RGT). By applying the linear sampling operation on RGTᵢ according to Fᵢ the framework can obtain RGT*ᵢ₊₁:

$${RGT}_{i + 1}^{*} = S ( {F}_{i} , {RGT}_{i} )$$

The framework can define the loss function corresponding to the pair of adjacent RGT traces RGTᵢ and RGTᵢ₊₁ as:

$${L}_{i} = {( {RGT}_{i + 1}^{*} - {RGT}_{i + 1} )}^{2}$$

The total loss function L can be defined as the sum of the loss function for pairs of adjacent RGT traces, both along inline (IL) and crossline (CL) directions:

$$L = {\sum }_{i \_ inline = 0}^{n \_ inline} {L}_{i \_ inline} + {\sum }_{i \_ crossline = 0}^{n \_ crossline} {L}_{i \_ crossline}$$

To calculate the loss function and its gradient for every trace pair for a seismic survey can be computationally intensive. As an example, a grid-based optimization technique can be employed that address such a computational challenge, for example, to increase efficiency and practicality. As an example, to reduce computational demands, a method may select gridlines based on a criterion such as every fifth gridline, every tenth gridline, every twentieth gridline, etc. Such a criterion may be a value between approximately two and forty. As an example, a method may utilize a value for a selection criterion that is within a smaller range, such as, for example, from ten to twenty.

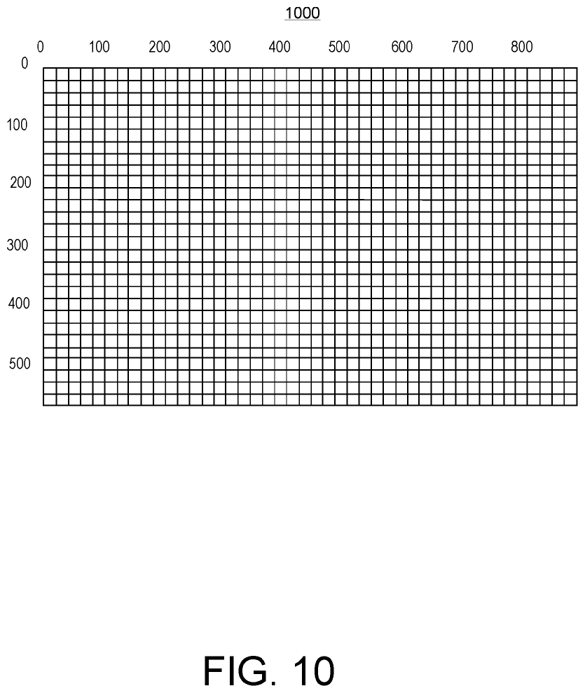

FIG. 10 shows an example of a grid 1000 with sparse vertical grid lines along both inline and crossline directions as may be selected from a seismic survey. Such a grid may be evenly spaced and/or customized with particular spacing that may aim to have increased accuracy or robustness over one or more regions. In the example, of FIG. 10, one grid line may be picked every 10 vertical slices. Instead of counting all the trace pairs, the grid-based loss function can count the trace pairs that are located on the grid lines. By minimizing the grid-based loss function, a framework can obtain a skeleton of an RGT that complies with the flow field (e.g., or another seismic attribute) better than an initial RGT. After a framework-based optimization is completed, the framework can track the RGT outside the grid lines starting from an RGT trace on a grid line as a seed trace where each of the grid lines can provide respective seed traces.

As an example, an initial value for a 3D RGT can be set as monotonically increasing value along a trace, with each trace sharing the same RGT value. For example, for given traces, RGT value can start from 0 at the top layer and increase by an increment (e.g., unit of 1, etc.) for each lower sample. An initial value can also be set as the RGT obtained using a flood fill algorithm.

A machine learning model version (e.g., neural network and/or other type of machine learning model) of the grid-based loss function can be developed through a library such as TENSORFLOW (Google LLC, Mountain View, California) or another suitable library. As an example, a flow field (e.g., or another seismic attribute) can be treated as input parameters and RGTs can be treated as training variables. An optimization process to minimize a grid-based loss function can be implemented, for example, as training of a machine learning model, which may be unsupervised, supervised or a combination of supervised and unsupervised. As an example, an unsupervised approach to learning (e.g., training) can be implemented in an automated manner without human intervention. For example, a framework can receive seismic data and process the seismic data to output horizons that are of improved quality due to lack of or diminished artefacts such as, for example, the “X” shape alias. As explained, such an approach can involve generating seismic attributes where such seismic attributes may be utilized directly and/or with preprocessing as input to a ML model technique that can, for example, determine appropriate RGT values, which may identify horizons. Such an approach can improve modeling, which can improve field operations (e.g., drilling to reach identified hydrocarbons in a subsurface region, etc.).

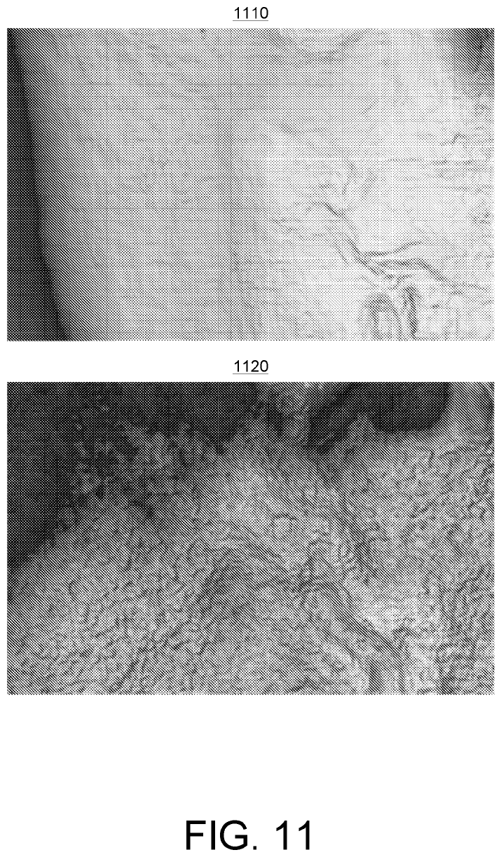

FIG. 11 shows images of example horizons 1110 and 1120 from processing of seismic data using an example optimization technique. The images 1110 and 1120 can be compared to the images 810 and 820 of FIG. 8. The images 1110 and 1120 of FIG. 11 are more accurate and therefore can be utilized to generate a more accurate model of a subsurface region. Such improved images can be utilized to more accurately identify a location or locations of hydrocarbons in a subsurface region and/or other objects (e.g., geo-objects, etc.), which may improve field development and associated operations. As explained, in various workflows, directional drilling may be employed that aims to maintain a portion of a borehole within reservoir boundaries. Where a reservoir is relatively thin, the task of navigating a drill bit within the reservoir boundaries can become more challenging, particularly as the drill bit may be at a measured depth of hundreds of meters, a thousand meters or more, etc., in a borehole in a subsurface region. Where the reservoir boundaries can be more accurately determined, drilling operations can be improved, which can improve reservoir contact for a borehole. As explained, increased reservoir contact can improve production of fluid from a reservoir.

As to types of machine learning models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model, may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a method can include implementing a linear 1-D interpolation on a regular (e.g., constant spacing) grid such as, for example, a grid akin to the grid 1000 of FIG. 10. In such an example, for a given batch of reference values, a function can compute a piecewise linear interpolant and evaluate it on a batch of new values.

As an example, a library such as, for example, the TENSORFLOW probability (TFP) library may be utilized and/or another library with interpolation techniques. The TFP library is a PYTHON library built on TENSORFLOW that provides for combining probabilistic models and deep learning on hardware (TPUs, GPUs, etc.). The TFP library provides techniques for making predictions and includes a selection of probability distributions and bijectors, tools to build deep probabilistic models, including probabilistic layers and a JointDistribution abstraction, variational inference and Markov chain Monte Carlo and optimizers such as Nelder-Mead, BFGS, and SGLD. TFP inherits TENSORFLOW features such that a framework can build, fit, and deploy a model using a single language throughout the lifecycle of model exploration and production. TFP provides integration of probabilistic methods with deep networks, gradient-based inference using automatic differentiation, and scalability to large datasets and models with hardware acceleration (e.g., GPUs) and distributed computation.

As an example, an interpolant can be built from C reference values indexed by one dimension of y_ref (specified by the axis kwarg) where if y_ref is a vector, then each value y_ref[i] can be considered to be equal to f(x_ref[i]), for C (implicitly defined) reference values between x_ref_min and x_ref_max. For example, consider:

$$x\_ref [ i ] = x\_ref \_min + i * ( x\_ref \_max - x\_ref \_min ) / ( C - 1 ) ,$$

$$i = 0 , … , C - 1.$$

As an example, for a general case, dimensions to the left of axis in y_ref can be broadcast with leading dimensions in x, x_ref_min, and x_ref_max.

In the TENSORFLOW library, a technique referred to as batch_interp_regular_1d_grid may be utilized, which returns y_interp as interpolation between members of y_ref, at points x and includes a fill_value argument that determines what values output are to have for x values that are below x_ref_min or above x_ref_max (e.g., consider a tensor or one of the strings constant_extension (extend as constant function) and extrapolate (extrapolate in a linear fashion)).

As an example, the aforementioned technique can interpolate a function of one variable:

y_ref = tf.exp(tf.linspace(start=0., stop=10., 20))
batch_interp_regular_1d_grid(
x=[6.0, 0.5, 3.3], x_ref_min=0., x_ref_max=10., y_ref=y_ref)
== > approx [exp(6.0), exp(0.5), exp(3.3)]

As an example, the aforementioned technique can interpolate a batch of functions of one variable:

```
# First batch member is an exponential function, second is a log.
implied_x_ref = [tf.linspace(−3., 3.2, 200), tf.linspace(0.5,
3., 200)]
y_ref = tf.stack( # Shape [2, 200], 2 batches, 200 reference
values per batch
  [tf.exp(implied_x_ref[0]), tf.log(implied_x_ref[1])], axis=0)
x = [−1., 1., 0.], # Shape [2, 3], 2 batches, 3 values per batch.
  [1., 2., 3.]]
y = tfp.math.batch_interp_regular_1d_grid( # Shape [2, 3]
  x, x_ref_min=[−3., 0.5], x_ref_max=[3.2, 3.], y_ref=y_ref,
  axis =−1)
# y[0] approx tf.exp(x[0])
# y[1] approx tf.log(x[1])
```

As an example, the aforementioned function can interpolate a function of one variable on a log-spaced grid:

```
  x_ref = tf.exp(tf.linspace(tf.log(1.), tf.log(100000.), num_pts))
  y_ref = tf.log(x_ref + x_ref**2)
  batch_interp_regular_1d_grid(x=[1.1, 2.2], x_ref_min=1.,
x_ref_max=100000.,
    y_ref, grid_regularizing_transform=tf.log)
==> [tf.log(1.1 + 1.1**2), tf.log(2.2 + 2.2**2)]
```

The foregoing technique is an example noting that one or more other interpolation techniques may be utilized, additionally or alternatively. For example, consider batch_interp_regular_nd_grid, which provides for multidimensional interpolation.

As an example, a technique may utilize various modules and classes. For example, in TENSORFLOW, consider the hypergeometric module (implements hypergeometric functions), the ode module (probability ODE solvers), and psd_kernels module (positive-semidefinite kernels package) along with the class MinimizeTraceableQuantities (named tuple of quantities that may be traced from tfp.math.minimize).

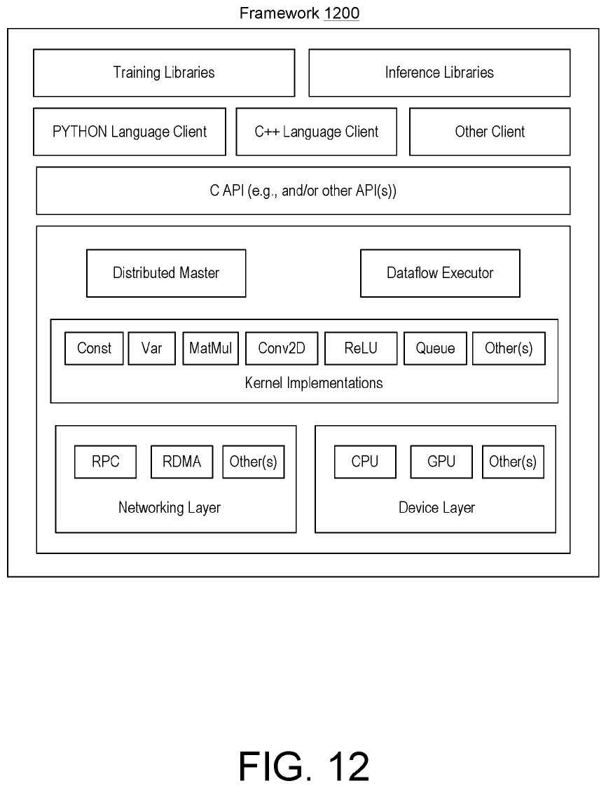

FIG. 12 shows an architecture 1200 of a framework such as the TENSORFLOW framework. As shown, the architecture 1200 includes various features. As an example, in the terminology of the architecture 1200, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

As an example, a framework can provide for seismic image segmentation, stratigraphic sequence interpretation and/or horizon tracking for subsurface interpretation and earth model building. Sequence stratigraphy provides interpretations, description and classification of sedimentary rocks based on their strata stacking patterns and their stratigraphic relations. A complete sequence stratigraphy interpretation on a seismic survey can follow principles of relative geological age such as principle of original horizontality, principle of lateral continuity and principle of superposition. Within a fully interpreted sequence stratigraphy or relative geological age volume, horizon tracking can involve manual picking a contour line/surface by selecting points with the same age value. As explained, an automated process can utilize a flow field approach with optimization (e.g., using interpolation, etc.). Given the principles of relative geological age, consider a tracked horizon to be a water-tight surface and that two tracked horizons do not intersect with each other, in other words, a tracked horizon is a loop-tie horizon.

As explained, information from picks, log data, etc., may be utilized in addition to seismic data in a workflow. For example, picks, layer boundaries from logs, etc., may be utilized to constrain an optimization technique. A constraint may ensure that points that belong to same horizon are not altered as to their membership as associated with that horizon. As an example, a method may implement one or more loss functions. For example, consider addition of a loss function that can minimize a value or values according to a priori knowledge. As another example, a method may fix a value or values according to a priori knowledge.

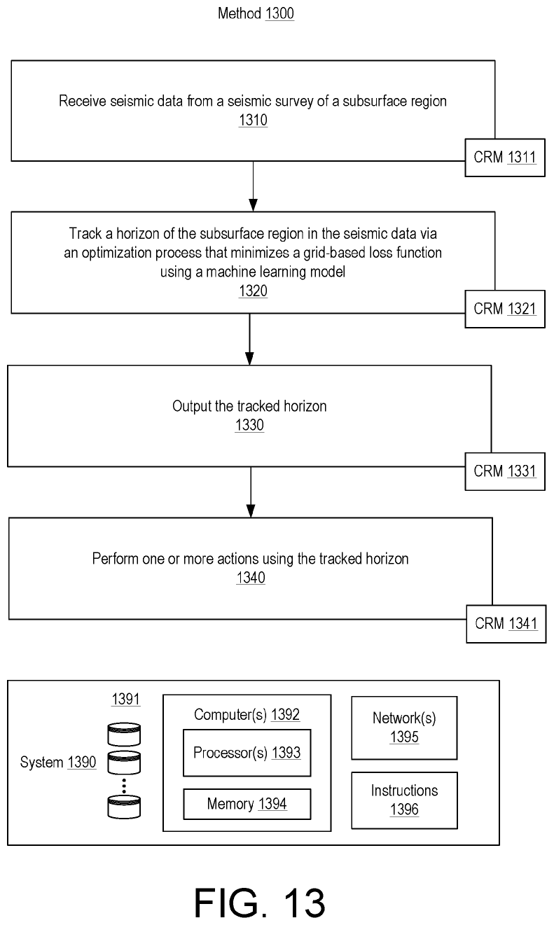

FIG. 13 shows an example of a method 1300 that includes a reception block 1310 for receiving seismic data from a seismic survey of a subsurface region and a tracking block 1320 for tracking a horizon of the subsurface region in the seismic data via an optimization process that minimizes a grid-based loss function using a machine learning model where the method 1300 can include an output block 1330 for outputting the tracked horizon and, for example, a performance block 1340 for performing one or more actions such as model building, simulation, planning, identification of hydrocarbons or other objects in the subsurface region, drilling, producing, and/or EOR.

In the example of FIG. 13, a system 1390 includes one or more information storage devices 1391, one or more computers 1392, one or more networks 1395 and instructions 1396. As to the one or more computers 1392, each computer may include one or more processors (e.g., or processing cores) 1393 and a memory 1394 for storing the instructions 1396, for example, executable by at least one of the one or more processors. As an example, a computer may include one or more network interfaces (e.g., wired or wireless), one or more graphics cards, a display interface (e.g., wired or wireless), etc.

The method 1300 is shown along with various computer-readable media blocks 1311, 1321, 1331 and 1341 (e.g., CRM blocks). Such blocks may be utilized to perform one or more actions of the method 1300. For example, consider the system 1390 of FIG. 13 and the instructions 1396, which may include instructions of one or more of the CRM blocks 1311, 1321, 1331 and 1341.

As an example, a method can include receiving seismic data from a seismic survey of a subsurface region; tracking a horizon of the subsurface region in the seismic data via an optimization process that minimizes a grid-based loss function using a machine learning model; and outputting the tracked horizon. In such an example, tracking can include utilization of a flow field defined between traces of the seismic data. In such an example, the flow field can be utilized as input parameters for the machine learning model where, for example, relative geological time may be utilized as training variables for the machine learning model.

As an example, given an initial relative geological time or another time and/or depth, minimization of a grid-based loss function can generate a skeleton of relative geological time or another time and/or depth that complies with the flow field better than the initial relative geological time or other time and/or depth.

As an example, a skeleton can corresponds to grid lines of a grid of a grid-based loss function. In such an example, an initial time and/or depth can be specified according to a monotonically increasing value.

As an example, a grid-based loss function can utilize a grid that is sparser than an inline and crossline grid of a seismic survey. In such an example, tracking a horizon can include selecting seed traces from grid lines of the grid where, for example, tracking includes assessing traces of the inline and crossline grid using the seed traces where the seed traces reduce tracking artefacts (e.g., reduce “X” shape alias).

As an example, tracking can utilize one or more of seismic amplitude with respect to time and seismic amplitude with respect to depth. In such an example, time may be travel time (e.g., travel time-based, etc.) or relative geological time.

As an example, a method can include generating a multidimensional model of a subsurface region using one or more tracked horizons. In such an example, the method can include performing a simulation of physical phenomena using the multidimensional model. As an example, a method can include identifying hydrocarbons and/or one or more other objects in the subsurface region.

As an example, a method can include receiving horizon location information and formulating one or more constraints based at least in part on the horizon location information where, for example, the horizon location information includes well log information from at least one well drilled in the subsurface region.

As an example, a method can include tracking that includes utilization of a seismic attribute derived from seismic data. For example, a flow field seismic attribute, a dip seismic attribute, etc., may be derived from seismic data where, for example, one or more of such types of seismic attributes may be utilized as input to a machine learning model for purposes of RGT determinations, which can provide for identifying one or more horizons in a subsurface geologic environment. As explained, unsupervised training may be utilized where RGTs can be training variables that are determined based on seismic attribute values as input.

As an example, an optimization process can utilize interpolation. For example, consider use of a machine learning model-based interpolation technique.

As an example, a system can include a processor; a memory accessible by the processor; processor-executable instructions stored in the memory and executable to instruct the system to: receive seismic data from a seismic survey of a subsurface region; track a horizon of the subsurface region in the seismic data via an optimization process that minimizes a grid-based loss function using a machine learning model; and output the tracked horizon.

As an example, one or more non-transitory computer-readable storage media can include computer-executable instructions executable to instruct a computing system to: receive seismic data from a seismic survey of a subsurface region; track a horizon of the subsurface region in the seismic data via an optimization process that minimizes a grid-based loss function using a machine learning model; and output the tracked horizon.

As an example, a computer program product can include instructions to instruct a computing system to perform one or more methods as described herein.

As an example, a system may include instructions, which may be provided to analyze data, control a process, perform a task, perform a workstep, perform a workflow, etc.

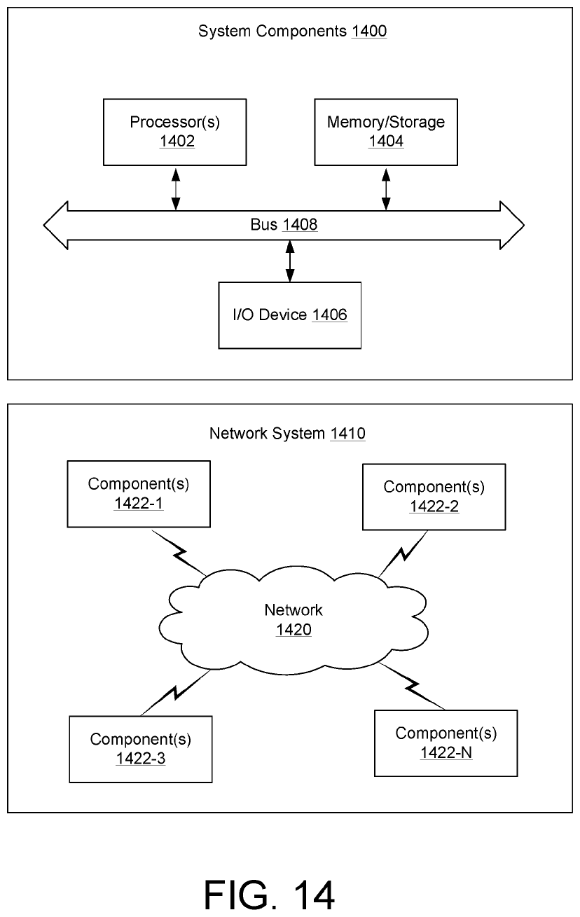

FIG. 14 shows components of an example of a computing system 1400 and an example of a networked system 1410 and a network 1420. The system 1400 includes one or more processors 1402, memory and/or storage components 1404, one or more input and/or output devices 1406 and a bus 1408. In an example embodiment, instructions may be stored in one or more computer-readable media (e.g., memory/storage components 1404). Such instructions may be read by one or more processors (e.g., the processor(s) 1402) via a communication bus (e.g., the bus 1408), which may be wired or wireless. The one or more processors may execute such instructions to implement (wholly or in part) one or more attributes (e.g., as part of a method). A user may view output from and interact with a process via an I/O device (e.g., the device 1406). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1410, which includes a network 1420. The network system 1410 includes components 1422-1, 1422-2, 1422-3, . . . 1422-N. For example, the components 1422-1 may include the processor(s) 1402 while the component(s) 1422-3 may include memory accessible by the processor(s) 1402. Further, the component(s) 1422-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving seismic data from a seismic survey of a subsurface region;
tracking a horizon of the subsurface region in the seismic data via an optimization process that minimizes a grid-based loss function using a machine learning model; and
outputting the tracked horizon.

2. The method of claim 1, wherein the tracking comprises utilization of a flow field defined between traces of the seismic data.

3. The method of claim 2, wherein the flow field is utilized as input parameters for the machine learning model.

4. The method of claim 3, wherein relative geological time is utilized as training variables for the machine learning model.

5. The method of claim 2, wherein, given an initial relative geological time, minimization of the grid-based loss function generates a skeleton of relative geological time that complies with the flow field better than the initial relative geological time.

6. The method of claim 5, wherein the skeleton of relative geological time corresponds to grid lines of a grid of the grid-based loss function.

7. The method of claim 5, wherein the initial relative geological time is specified according to a monotonically increasing value.

8. The method of claim 1, wherein the grid-based loss function utilizes a grid that is sparser than an inline and crossline grid of the seismic survey.

9. The method of claim 8, wherein the tracking comprises selecting seed traces from grid lines of the grid.

10. The method of claim 9, wherein the tracking comprises assessing traces of the inline and crossline grid using the seed traces.

11. The method of claim 10, wherein the seed traces reduce tracking artefacts.

12. The method of claim 1, wherein the tracking utilizes one or more of seismic amplitude with respect to time and seismic amplitude with respect to depth.

13. The method of claim 12, wherein the time is travel time or relative geological time.

14. The method of claim 1, comprising generating a multidimensional model of the subsurface region using the tracked horizon.

15. The method of claim 14, comprising performing a simulation of physical phenomena using the multidimensional model.

16. The method of claim 1, comprising receiving horizon location information and formulating one or more constraints based at least in part on the horizon location information, wherein the horizon location information comprises well log information from at least one well drilled in the subsurface region.

17. The method of claim 1, wherein the tracking comprises utilization of a seismic attribute derived from the seismic data.

18. The method of claim 1, wherein the optimization process utilizes interpolation.

19. A system comprising:
a processor;
a memory accessible by the processor;
processor-executable instructions stored in the memory and executable to instruct the system to:
receive seismic data from a seismic survey of a subsurface region;
track a horizon of the subsurface region in the seismic data via an optimization process that minimizes a grid-based loss function using a machine learning model; and
output the tracked horizon.

20. One or more non-transitory computer-readable storage media comprising computer-executable instructions executable to instruct a computing system to:
receive seismic data from a seismic survey of a subsurface region;
track a horizon of the subsurface region in the seismic data via an optimization process that minimizes a grid-based loss function using a machine learning model; and
output the tracked horizon.
